(19) United States
(12) Patent Application Publication
(10) Pub. No.: US 2007/0156655 A1
(43) Pub. Date: Jul. 5, 2007

(54) Method of retrieving data from a data repository, and software and apparatus relating thereto

(76) Inventors: Mark Henry Butler, Bristol (GB); David Murray Banks, Bristol (GB); Scott Alan Stanley, Pleasanton, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/493,006

(22) Filed: Jul. 26, 2006

(30) Foreign Application Priority Data
Oct. 27, 2005 (GB) 0521901.9

(51) Int. Cl. G06F 17/30

(52) U.S. Cl. 707/3

(57) ABSTRACT

A method of providing data from a data repository to a client application, comprises receiving an initial query from a client application and obtaining a first set of results from the data repository to the initial query. If the total number of results of the first set is greater than a predetermined number for provision as a single page, a second set of results is stored in memory and a page of results is provided. An indication of the total number of results to the initial query is provided as well as an indication of the position of the results of the page within the set of results, and an indication of the range of the results for which subsequent queries will return results consistent with the initial query. This provides a results paging model to allow a client application to page through a large set of query results, with transparent indication of the consistency between the pages of results.

### RELATED APPLICATION

The present application is based on, and claims priority from, GB Application Ser. No. 0521901.9, filed Oct. 27, 2005, the disclosure of which is hereby incorporated by reference herein in its entirety.

### FIELD OF THE INVENTION

The invention relates to the accessing of data stored in data repositories, in order to obtain results sets, and particularly to the paging of large sets of such results.

### BACKGROUND OF THE INVENTION

There are many applications in which a large amount of content is stored in a repository, with access to the data stored through a network such as the internet.

A data repository may take the form of a conventional database that stores content in records having a number of fields. In conventional databases, some of the fields are indexed so that data in the indexed fields is stored in a separate index. The separate index may be searched for specific search terms to identify records including those search terms.

There is a trend to provide larger and larger data repositories, to enable the centralised storage of large data sets. For example, there is an increasing requirement to store large volumes of data to meet new legislative requirements concerning the storage of historical data.

By way of example, companies may store all email traffic in a central data repository. The number of emails sent and received by the employees of a multinational organisation of course requires a very large data repository, which will typically store vast numbers of relative small data objects. Alternatively, a very large data repository is also required to store relatively few data objects, when these are themselves of significant size, such as video data objects.

As the size of these data repositories increases, the number of results which are returned in response to a given enquiry also increases. For example, a repository may have several terabytes of data. Certain degenerate queries may result in (potentially) all the metadata in the repository being returned to the client application. It is more desirable for the quality of the returned results to degrade than for the server to be impacted.

In a client/server design model, this type of degenerate query by the client should not be allowed to significantly impact the performance or stability of the server. A data repository of this type typically has an interface for multiple client applications, and the server should continue to function for the other client applications. The interface supports the input of queries to the repository and the supply of the responses to the queries. One convenient communications protocol for the communications is HTTP, and the interface can then define a web service environment.

Even for legitimate queries, the data repository may return very large results sets. Due to resource limitations on the client applications and the server for the data repository, there may be situations where it is not practical to return these large results set in a single HTTP response. One approach is accordingly to split the complete results set into smaller subsets that are retrieved by the client with separate HTTP requests.

The splitting of results may be desirable due to a desire to ensure the client receives a response quickly, or it may be due to a fundamental limitation, for example timeouts in a HTTP protocol or resource usage, such as memory, on the server or client. Therefore, a repository may typically choose to limit the results set transmitted to the client. However, when the server has limited the returned results, the client application is preferably provided with a mechanism to obtain the rest of the results for the query.

In view of the stateless nature of web services and HTTP, it is known for results sets to be cached on the data repository server in order to maintain order between requests and therefore provide a totally consistent view to the client application. The data repository server thus typically includes a cache for this purpose, and which has a data capacity which is smaller than the total data capacity of the repository.

If the repository only spans data that is currently static, then it is simple for the server to present a consistent view of the results to the client by submitting a new backend query and maintaining an index internally to the last result given to the client. Each subsequent request by the client to obtain more of the results causes a new query being submitted, followed by the server indexing into the results set using the saved pointer and returning the next set of results.

However, when the data set returned by the query is not static, this results in the client seeing an inconsistent view of the results. Between the initial submission of the query and the resubmission when the client application requests more results, the underlying data may change resulting in the size of the results set changing. In this scenario, the only mechanism the server can use to maintain a consistent view for the client is to cache the results of the initial query. There are of course limits on the size of a cached results set that a repository can store.

If results are cached on the server, it is also significant that the client and server are communicating via a stateless web based application program interface (API). Therefore, if some state needs to be maintained between subsequent client requests, a mechanism needs to be devised to maintain this state across an otherwise stateless interaction.

The issues have been recognised in the past, and existing databases and internet search engines provide the feature of paging through results sets. It is known for these paging facilities to allow users to set the maximum page size and select which page to retrieve results.

Databases typically implement this mechanism in a number of ways.

One approach is to lock the data spanned by the query in order to enable a consistent view across the results to the client. This type of approach is not feasible when a query may possibly span all results in a data repository containing terabytes of data.

Some Java Database Connectivity implementations provide this capability by extracting the results of the initial query to the client, then provide a mechanism for paging through the results on the client. Such an approach is not desirable, since the client is still incurring the cost of having to retrieve the entire results set.

Internet search engines, like Google (trade mark), enable the client to select the record from which the results set begins, and this information is placed in the HTTP request. Likewise, the number of results to include in a single page may be set by the client and is stored in a cookie as part of the session. However, internet search engines work on a much more static set of data than is typically present in a data repository. Typically, an internet search engine slowly adds new content to an index while old content is retained for a very long time. This effectively makes the data static, or at most very slowly changing.

These approaches are not suitable in a dynamic data repository, and one in which the transmission of a very large data set to the client application is to be avoided.

### SUMMARY OF THE INVENTION

According to the invention, there is provided a method of retrieving data from a data repository, comprising:

submitting an initial query;

receiving a page of results to the query, the page containing a sub-set of the results to the initial query;

receiving an indication of the total number of results to the initial query;

receiving an indication of the position of the page's results within the total results to the query; and

receiving an indication of the range of the results for which subsequent queries will return results consistent with the initial query.

According to a second aspect of the invention, there is provided a method of providing data from a data repository to a client application, comprising:

receiving an initial query from a client application;

obtaining a first set of results from the data repository to the initial query;

if the total number of results of the first set is greater than a predetermined number:
storing a second set of results in memory, the second set of results being greater in number than the predetermined number and less than or equal to the total number of results of the first set;
providing a page of results to the initial query to the client application, the page containing the predetermined number of the results;
providing an indication of the total number of results to the initial query to the client application;
providing an indication of the position of the page's results within the set of results; and
providing an indication of the range of the results for which subsequent queries will return results consistent with the initial query, the range of results comprising the second set of results.

The invention also provides computer program comprising computer program code means adapted to perform the method of the second aspect of the invention.

According to a third aspect of the invention, there is provided a data repository system comprising:

a data repository; and

a client interface for receiving queries from client applications and returning results to the client applications, wherein the client interface is adapted to:
receive an initial query from the client application;
obtain a first set of results from the data repository to the query;
if the total number of results of the first set is greater than a predetermined number:
   store a second set of results in memory, the second set of results being greater in number than the predetermined number and less than or equal to the total number of results of the first set;
   provide a page of results to the initial query to the client application, the page containing the predetermined number of the results;
   provide an indication of the total number of results to the initial query to the client application;
   provide an indication of the position of the page's results within the set of results; and
   provide an indication of the range of the results for which subsequent queries will return results consistent with the initial query, the range of results comprising the second set of results.

### BRIEF DESCRIPTION OF THE DRAWINGS

An example of the invention will now be described in detail with reference to the accompanying drawings, in which:

FIG. 1 shows a data repository system of the invention; and

FIG. 2 is used to explain a method of providing query results from the data repository.

### DETAILED DESCRIPTION

The example of the invention described below provides a paging mechanism for handling large sets of results in response to a query to a data repository.

The results paging model provides a mechanism for a server to allow a client application to page through a large set of query results, with transparent indication of the consistency between the pages of results. The mechanism allows the server to provide a clear description to the client application of the region of the query results that remains consistent.

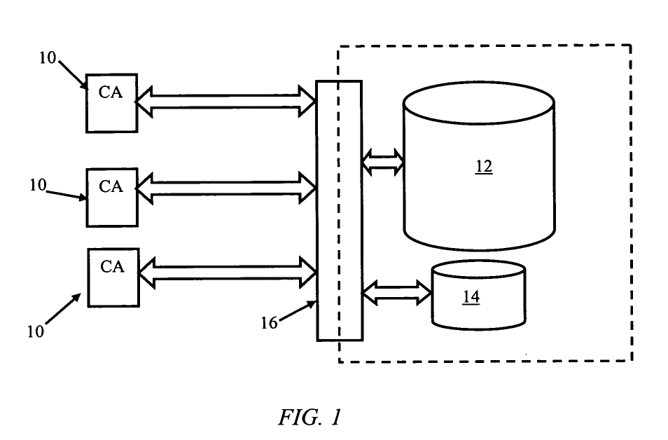

FIG. 1 shows in schematic form the overall system of the invention.

The system shown in FIG. 1 is a data repository system, in which client applications 10 access the data stored in a data repository 12. The client applications handle data repository search queries, and multiple client applications 10 may have (substantially) simultaneous access to the data repository 12. The system includes a cache memory 14 used in the provision of results to the client applications 10, and a client interface 16 converts the communications from the client applications into control commands for the data repository 12 and cache 14. The data repository, cache and interface together may be considered to define a server.

The data repository can store large amounts of data, for example terabytes of data, and this may also be of a very dynamic nature, namely susceptible to vary more quickly than the time spent paging the results. For such large volumes of data, the query may take minutes or hours to process, and may provide thousands of results.

The messages between the client interface 16 and the client applications may use HTTP messages, and these may be provided over a web network, or other stateless network.

The client interface 16 receives an initial query from one of the client applications, and uses this to interrogate the data repository, in order to obtain a first set of results. The number of results of the first set may be greater than a maximum number of results for display as a single page, and the system then caches a second set of results in memory. A page of results is then provided to the client application, but in addition there are provided:

an indication of the total number of results to the initial query;

an indication of the position of the results of the page within the total set of results; and

an indication of the range of the results for which subsequent queries will return results consistent with the initial query, this range of results corresponding to the cache content.

If pages of the results which are outside the consistency range enabled by the cache are demanded, a new query is required to generate a new set of results.

This technique thus combines two distinct approaches to managing the results of a query submitted by a client application; (1) caching of the results in memory on the server to provide a consistent view and (2) paging by submission of new queries, thus minimizing resource usage on the server. These approaches are blended to enable a consistent view across relatively small numbers of results while still enabling browsing through larger results sets by accepting some possible inconsistency of the results.

The behaviour of the server is controlled through four distinct parameters:

MaxResults

The maximum number of results that the server allows to be returned in a single page of results.

MaxCon

The maximum number of query results that can be paged through in a consistent fashion. This is linked to the size of the cache 14 of the server used for holding query results between subsequent paging requests by the client.

MaxQuery

The maximum number of results the server will allow a client to retrieve for any individual query.

DefaultOrdering

This describes the way the repository orders results by default.

These parameters enable the server to fully describe its behaviour to a client application to provide full transparency of the nature of the results provided in response to a client query.

In most applications, the value of MaxQuery will be greater than the value of MaxCon (namely a larger result set is allowed than can be stored in the cache), and the value of MaxCon will be larger than MaxResults (namely consistency will be maintained across multiple pages of results).

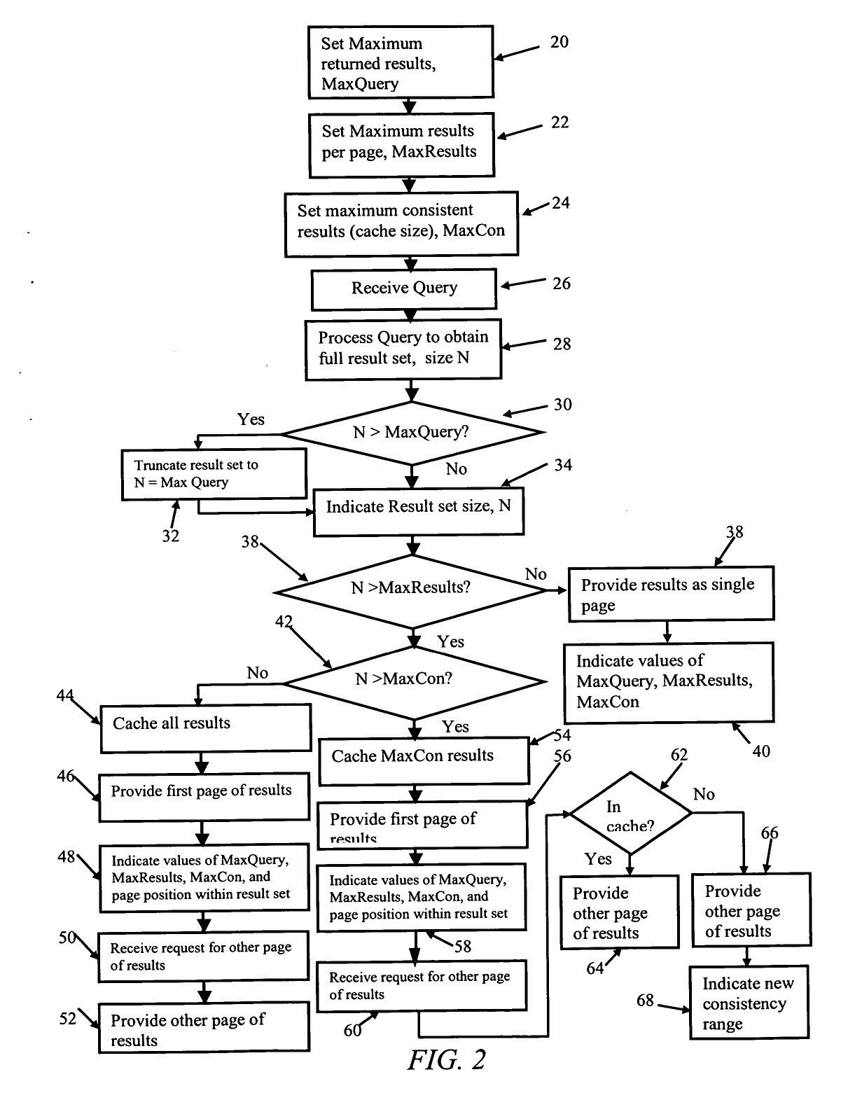

The method implemented by the system of FIG. 1 is explained with reference to FIG. 2.

When a client application sends a query to the server, it includes a flag (ConsistentResults) with that query which indicates if the client application requires paging of the results to be consistent. If the client does not request consistent handling of the results, the server may treat the results either consistently or not. For example, the cache may not be used if consistency of results is not required.

This option is not shown in FIG. 2, and it is assumed that consistency of the results is desired.

In steps 20, 22, 24, the values of the maximum total number of results (MaxQuery), the maximum results per page (MaxResults) and the maximum number of consistent results (MaxCon) is set. These parameters determine the type of behaviour of the system. These parameters may be set by the server in response to the type of data stored, or else they may be varied in response to requests from the client application, although the limit of the MaxCon parameter is linked to the cache size. These steps 20, 22, 24 may or may not form part of the communication between the client applications and the server, and it will be understood from the above that these steps may form part of the installation of the server.

In step 26, a query is received from the client application (and correspondingly, a query is sent by the client application). This query is processed in step 28 to return the full result set. It is assumed that this result set has size N, namely N entries are returned in response to the query.

In step 30 it is determined whether or not this number of entries is larger than the maximum allowed result set, and if so, the full result set is truncated in step 32. The size of the result set, which may be MaxQuery or smaller, is provided to the client application in step 34.

The size of the result set is then compared to the maximum page size in step 36. This maximum page size determines the amount of data to be downloaded to the client application. If the full result set can be provided as a single page, this page is provided in step 38, as well as the values of MaxQuery, MaxResults and MaxCon (step 40). In this case, the full result set has been provided as a single page. This will be apparent to the client application, as the value N is less than MaxResults and MaxCon.

If the full result set cannot be provided as a single page, it is then determined in step 42 if the full result set can be provided with consistency. This will be possible if the full result set size N is less than the value of MaxCon.

In this case, all results can be cached in step 44, the first page can be provided to the client application in step 46 and again the values of MaxQuery, MaxResults and MaxCon are provided (step 48). In addition, information concerning the position of the returned page within the total result set is provided. As shown in step 50, the client application can request further pages of results, and these can be provided from the cache in step 52, with consistency between the results of different pages.

If the full result set cannot be cached, the maximum number of results are cached in step 54. Again, the first page can be provided to the client application in step 56 and the values of MaxQuery, MaxResults and MaxCon and page position information are provided (step 58). In step 60, the client application can again request further pages of results.

These may or may not be available from cache. and this is determined in step 62. Further pages of results are provided from the cache in step 64, with consistency between the results of different pages. If pages outside the consistency range are requested, a new query is initiated to provide the further results in step 66, and these will have a new consistency range which is indicated to the client application. This will become clear from the example below.

It is noted that the specific order of the steps in the flow chart of FIG. 2 is not important, and the order has been selected to make the logical considerations most easily understood.

It can be seen that when the server responds to a query, a number of pieces of metadata are always returned with the results of the query.

Most important of these are the total size of the results set for the query, N, and the maximum number of results the server will allow, MaxQuery.

If the actual number of results from the query exceeds MaxQuery, the query results will be truncated and N will be equal to MaxQuery. This provides an indication to the client application that the result set has been truncated.

As can be seen from the above, paging is only invoked if N is more than the maximum page size, and only a subset of the results set is returned, in the form of a page including MaxResults results. It should be noted that a page is a predetermined number of results in a result set to be sent from the server to the client application and does not relate to any physical layout of the result listing.

When paging is invoked, additional metadata is provided with the results describing the paging behaviour of the server. This additional metadata includes the index of the first and last result in this page within the results set (known as Begin and End, respectively). The server also sends back a QuerylD to the client application which the client application can use to retrieve subsequent pages in the results set.

If the ConsistentResults flag has been set by the client application, and the server supports results caching, then the server will cache as many results as it can in order to give the client a consistent view. There will always be a limit to the amount of caching the repository can do, specified by the value MaxCon.

In the example above, the value of MaxCon is also returned to the client application, in order to describe what can be cached. In more detail, the caching can instead be described by two additional pieces of information returned, MaxConsistentBegin and MaxConsistentEnd. These values define a window on the results set, larger than the paging window, where subsequent calls to the server using the query handle will return the requested results set consistent with the current page.

As shown above, in the case of small queries, this window could encompass the entire results set, but in the case of large queries it might only by a subset of the results set. If the client requests a page of results that is beyond MaxConsistentEnd, then a new query is submitted internally and the results are no longer guaranteed to be consistent with the first set.

A simple example can illustrate the operation of the system of the invention more concisely.

A server may be set to provide a maximum number of results per page of MaxResults=1000, a maximum caching facility of MaxCon=10,000 and a maximum permitted result set of MaxQuery=15,000.

If a query is submitted generating a results set with a total record count of 20,000, the server will truncate this to 15,000 (MaxQuery) allowing the client to see only 15,000 results. The response from the server will return a results page from results 1 to results 1000.

It will also state that the result set size N and MaxQuery are both 15,000, indicating that the results have been truncated. It will also state the MaxConsistentBegin and MaxConsistentEnd values are 1 and 10,000 (in other words MaxCon=10,000). In this scenario, the client can use the returned QuerylD to request the pages from 1001 to 2000, 2002 to 3000 etc up to 10000 and the results will all be consistent. However when a request is made for 10,001 to 11,000 the server no longer guarantees that the results will be consistent with the previous, as a new query is operated. Thus, a particular result that has already been returned might be in the results set because the results set is reordered.

In the response to the request for page 10,001 to 11,000 the server will respond indicating that the MaxConsistentBegin and MaxConsistentEnd has shifted to 10,001 and 15,000 respectively and a new QuerylD will be returned. This means the client can use the new QuerylD to obtain a consistent view on the remaining results.

The policy for retaining results sets in the cache can be determined by the server. The cache could be used with removal of cached results sets from the server based on which one was used the longest time ago, or a more formal policy could be implemented where a client application explicitly states to the server it has finished with a results set before it can be removed.

The parameters describing the server operation, MaxResults, MaxCon and MaxQuery can be used to describe a range of paging behaviour in the server.

For example, if all three values are the same this indicates the server does not support paging at all and all results will be returned in the initial response, with the result set truncated to one page.

If MaxResults and MaxCon are the same, and MaxQuery is larger then this indicates the server does not support consistent paging. In this scenario, all paging requests will result in the submission of a new query and no guarantees are made on the consistency across page requests.

If MaxCon and MaxQuery are the same and MaxResults is smaller then this indicates the server always caches the query results and all page requests will be consistent.

This flexible mechanism for describing the paging behaviour enables individual repositories to implement the behaviour they desire in the query system. However a broad range of distinct behaviours can be described using the same mechanism.

A paging interface is thus provided that allows subsets of results sets to be retrieved. This approach also uses defined windows to define the consistency of results, and these windows are separate from the paging approach. This provides flexibility by recognising that not all systems will be able to provide a consistent view across the results of all queries.

This approach is compatible with a stateless web service application program interface, and is suitable for use with so-called semi-structured databases, which evolve more rapidly than conventional relational databases. The storage of application data in a so-called “semi-structured” format has become common in archival storage devices. So called “semi-structured” data has a structure which is not regular and does not have a fixed format. The data can quickly evolve. There is also a blurring between the structure and the data stored by the structure.

The use of a cache is of particular benefit when HTTP is used for the transmission of the results sets, either using REST or SOAP, in order to keep the volume of HTTP traffic down. However, other protocols, such as RMI may also be used for the client application-server communications. The invention is of particular benefit for data repositories for large volumes of data or data which is rapidly changing, such as data repositories for storing emails or hard-drive backup data, for document stores for large companies, or for large audio or video files.

FIG. 1 shows only one simplified data repository system. The data repository may be implemented as a router which communicates with multiple data stores, in the form of so-called “smart cells”. The repository may also act as an index rather than a data store, with the content being obtained from other locations as determined by the indexes stored in the central data repository.

The flow chart of FIG. 2 has been used to explain the operation of the server. However, the operation of the client application and the information received by the client application during the query and results communications is also clear the figure and the description thereof.

Various other modifications will be apparent to those skilled in the art.

We claim:

1. A method of retrieving data from a data repository, comprising:
submitting an initial query;
receiving a page of results to the query, the page containing a sub-set of the results to the initial query;
receiving an indication of the total number of results to the initial query;
receiving an indication of the position of the page's results within the total results to the query; and
receiving an indication of the range of the results for which subsequent queries will return results consistent with the initial query.

2. A method as claimed in claim 1, further comprising receiving an indication of the maximum total number of results.

3. A method as claimed in claim 1, further comprising receiving an indication of the maximum number of results per page.

4. A method as claimed in claim 1, wherein the indication of the range of results comprises an indication of a first and last result within the total series of results

5. A method of providing data from a data repository to a client application, comprising:
receiving an initial query from a client application;
obtaining a first set of results from the data repository in response to the initial query;
if the total number of results of the first set is greater than a predetermined number for provision as a single page:
storing a second set of results in memory, the second set of results being greater in number than the predetermined number and less than or equal to the total number of results of the first set;
providing a page of results to the initial query to the client application, the page containing the predetermined number of the results;
providing an indication of the total number of results to the initial query to the client application;
providing an indication of the position of the page's results within the set of results; and
providing an indication of the range of the results for which subsequent queries will return results consistent with the initial query, the range of results comprising the second set of results.

6. A method as claimed in claim 5, wherein, if the total number of results of the first set is less than or equal to the predetermined number, the method comprises providing the first set of results as a page of results to the client application.

7. A method as claimed in claim 5, wherein if the total number of results of the first set is greater in number than the number of results of the second set, the method further comprises:
providing an indication of the size of the second set, thereby indicating that the range of the results for which subsequent queries will return results consistent with the initial query is less than the total number of results of the first set.

8. A method as claimed in claim 5, wherein the method further comprises limiting the number of results of the first set to a maximum number of results.

9. A method as claimed in claim 8, wherein the method further comprises:
providing an indication of the maximum number of results.

10. A method as claimed in claim 5, wherein providing the page of results, the indication of the total number of results, the indication of the position of the page's results within the set of results and the indication of the range of the results for which subsequent queries will return results consistent with the initial query each comprise providing an HTTP message.

11. A computer program comprising computer program code means adapted to perform all of the steps of claim 5 when said program is run on a computer.

12. A computer program as claimed in claim 11 embodied on a computer readable medium.

13. A data repository system comprising:
a data repository; and
a client interface for receiving queries from client applications and returning results to the client applications, wherein the client interface is adapted to:
receive an initial query from the client application;
obtain a first set of results from the data repository to the query;
if the total number of results of the first set is greater than a predetermined number for provision as a single page:
store a second set of results in memory, the second set of results being greater in number than the predetermined number and less than or equal to the total number of results of the first set;
provide a page of results to the initial query to the client application, the page containing the predetermined number of the results;
provide an indication of the total number of results to the initial query to the client application;
provide an indication of the position of the page's results within the set of results; and
provide an indication of the range of the results for which subsequent queries will return results consistent with the initial query, the range of results comprising the second set of results.
